(19) United States
(12) Patent Application Publication
(10) Pub. No.: US 2009/0068553 A1
(43) Pub. Date: Mar. 12, 2009

(54) SILICON MODIFIED NANOFIBER PAPER AS AN ANODE MATERIAL FOR A LITHIUM SECONDARY BATTERY

(75) Inventor: David W. Firsich, Dayton, OH (US)

Correspondence Address: THOMPSON HINE L.L.P.;Intellectual Property Group, P.O. BOX 8801, DAYTON, OH, 45401-8801, US

(73) Assignee: INORGANIC SPECIALISTS, INC., Miamisburg, OH (US)

(21) Appl. No.: 12/206,009

(22) Filed: Sep. 8, 2008

Related U.S. Application Data
(60) Provisional application No. 60/970,567, filed on Sep. 7, 2007.

(51) Int. Cl. B32B 3/26; B32B 9/00; H01M 6/00; H01G 9/00

(52) U.S. Cl. 429/122; 428/446; 428/332; 428/311.51; 428/336; 361/500

(57) ABSTRACT

A paper comprising a silicon-coated web of carbon nanofibers. The paper can be formulated such that it is useful as an energy storage material and/or a current collector. An asymmetric electrochemical capacitor containing the paper is also disclosed.

This application claims the benefit of U.S. Application Ser. No. 60/970,567 filed Sep. 7, 2007, the contents of which are incorporated herein by reference.

### BACKGROUND

This disclosure relates to a silicon coated carbon nanofiber paper and to a lithium secondary battery having an improved negative electrode with high energy storage, and in particular a lithium ion battery where the improved negative electrode can function as both an energy storage material and a current collector. It also relates to a ‘hybrid’ electrochemical capacitor, where the disclosed anode is mated with a cathode that has high capacitance or pseudocapacitance.

### SUMMARY OF THE INVENTION

One embodiment of this invention is a conductive and porous silicon-coated carbon nanofiber paper and an electrode made from it that has good cycling features and high energy storage. The coated paper and the electrode made from it are suitable for use as both an energy storage material and as a current collector.

### BRIEF DESCRIPTION OF THE DRAWINGS

FIG. 1A is a schematic illustration of a carbon fiber having a stacked cup structure used in one embodiment of the invention.

FIG. 1B is a scanning electron microscope image of a carbon nanofiber used in one embodiment of the invention.

FIG. 2 is a scanning electron microscope image of a paper formed from carbon nanofibers used in one embodiment of the invention.

FIG. 3A is a schematic illustration of the effect of depositing silicon and the subsequent incorporation of lithium ions in a less porous carbon nanofiber paper, and FIG. 3B is an illustration of the analogous effects using a more porous paper.

FIG. 4 is a graph of the cycling data obtained for a nanofiber paper incorporating a silicon particulate.

FIGS. 5A and 5B, respectively, are graphs of the discharge cycle and voltage profiles for the paper of Example 1.

FIGS. 6A and 6B, respectively, are graphs of the discharge cycle and voltage profiles for the paper of Example 2.

FIGS. 7A and 7B, respectively, are graphs of the discharge cycle and voltage profiles for the paper of Example 3.

FIG. 8 is a graph of capacity versus cycling number for the paper of Example 4 wherein the black points in the graph correspond to reversible capacity and the gray points correspond to the sum of irreversible and reversible capacity.

### DETAILED DESCRIPTION OF THE INVENTION

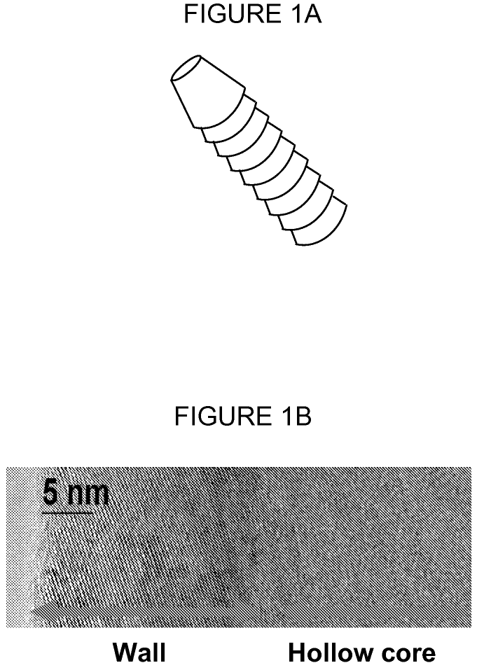

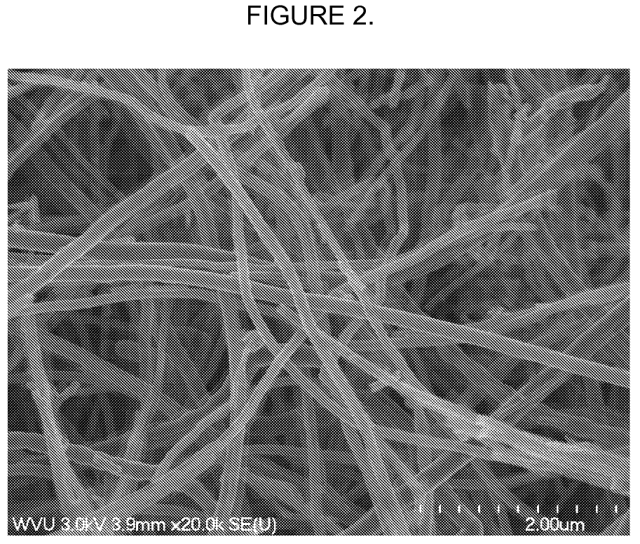

Nanofiber paper, as described in patent application Ser. No. 11/586,358 (Carbon Nanofiber Paper and Applications, the disclosure of which is incorporated herein by reference) is a flexible, porous, conductive sheet. In one embodiment, the carbon nanofibers that comprise the paper have a ‘stacked-cup’ morphology, as shown in FIG. 1A and as described and illustrated in the aforesaid application. When the paper is formed from nanofibers of this type, such as 60 nm PR-25 nanofibers from Applied Sciences in Cedarville Ohio, it has a high surface area of about 40 m²/g. Such a paper can be fabricated in a high-porosity (about 50-95% by volume), low density form by the procedures cited in the aforesaid application, producing a nonwoven material with a highly open structure. FIG. 2 is a scanning electron micrograph of a nanofiber paper used in one embodiment of this disclosure.

In one embodiment, the carbon nanofiber paper substrate is characterized by one or a combination of the following: fibers having a diameter less than about 100 nm (e.g., about 10 to 100 nm); a surface area greater than about 10 m²/g (as determined by BET nitrogen adsorption); a porosity of about 50 to 95% by volume; a density of about 0.05 to 0.8 g/cc; and a conductivity of about 0.01 to 100.0 ohm⁻¹-cm⁻¹.

Such a conductive paper form of high-surface-area nanofibers can be coated with a thin layer of silicon by any number of vapor deposition techniques, such as chemical vapor deposition, pulsed laser deposition, plasma chemical vapor deposition, physical vapor deposition, electron beam, or magnetron sputtering. Alternatively, chemical methods for depositing thin layers of silicon throughout the porous nanofiber structure might include the thermal decomposition of non-volatile silicon-containing compounds or polymers, or organic-solvent-based electrodeposition. Vapor deposition, especially chemical vapor deposition, using a silicon source gas such as tetrachlorosilane, trichlorosilane, or trichloromethylsilane, is one method for applying the silicon.

In one embodiment a silicon deposition technique is used to apply a uniformly thin silicon coating throughout the nanofiber paper. However, within the scope of the invention are silicon coated nanofiber papers with different levels of silicon at various depths into the nanofiber paper surface, recognizing that deposition techniques generally produce coatings that are thicker near a porous body's surface than in the interior.

By using a low density nanofiber paper as a substrate, it is possible to create an electrode with a high silicon content, and thus a high energy storage capacity as an anode material in a lithium ion battery. For example, if a paper consisting of 60 nm diameter nanofibers that individually have a density of 1.6 g/cc is uniformly coated with a 10 nm layer of silicon, the resulting paper would contain 49% Si by weight and have a theoretical energy storage capacity as high as 2058 mAh/g due to the silicon content (silicon has a theoretical lithium-ion anode energy storage of ˜4200 mAh/g). Nanofiber paper substrates in accordance with one embodiment of the invention have the ability to host a high silicon content in a thin-film form, which promotes cycling stability without a loss of storage capacity. In accordance with one embodiment of the invention, the silicon modified paper includes a silicon coating about 2 to 200 nm thick and more particularly about 2 to 50 nm thick, and has a silicon content of about 10 to 90% and more particularly about 15 to 50% relative to the total weight of the coated paper.

The adhesion of silicon to its conductive carbon-fiber support is believed to be one factor that contributes to a practical electrode that will cycle repeatedly. In one embodiment, the nanofiber paper is made from a specific fiber type (the stacked cup structure). This fiber type has carbon edge planes covering fiber surfaces, which are sites for chemical bonding. This contrasts with the structure of most nanotube varieties which exhibit basal plane exteriors having no valences for chemical attachment. While not desiring to be bound, the use of the stacked-cup fiber is believed to promote chemical bonding between silicon and carbon, and is especially well-suited for chemical vapor deposition at elevated temperatures. Other carbon nanofiber structures that are also believed useful include stacked platelet, concentric tube, herringbone, spiral-sheet tubular structures, and fibers having an amorphous or turbostatic carbon surface.

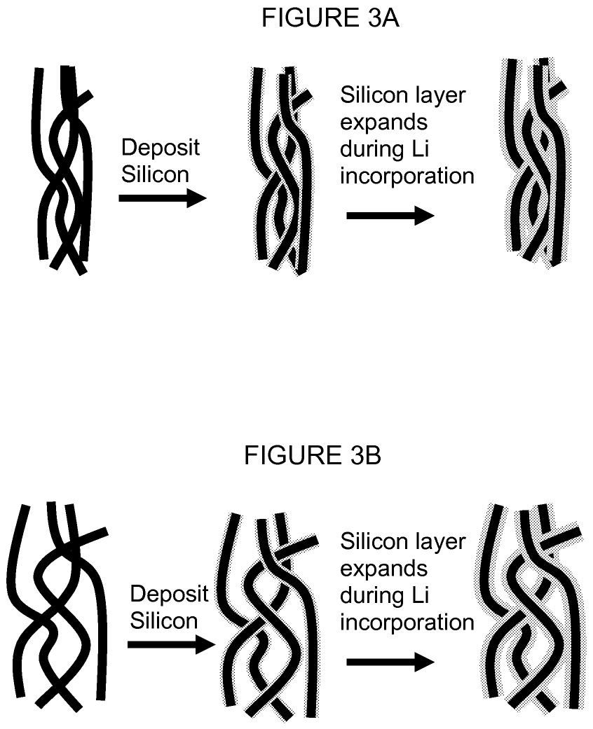

The nanofiber paper substrate can be produced in a low density form. For example, a 60 nm diameter PR-25 nanofiber from Applied Sciences has a density of 1.6 g/cc. A paper made from it can be made with a density of 0.16 g/cc, so that it is 90% porous. The void volume in the nanofiber paper matrix is desirable for three reasons: First, it allows a vapor deposition technique to deposit silicon deep within the porous structure, so a large quantity of silicon can be hosted. Second, the porosity accommodates the volume expansion of the silicon deposits as they insert lithium (silicon is known to undergo a large, reversible volume change of up to 250% as it incorporates and releases lithium). Third, it provides void space for the lithium-containing electrolyte liquid that fills these cavities and makes the battery function. This is schematically shown in FIGS. 3A and 3B.

The void volume of the paper is a function of a number of factors including the length of the fibers or the nanofiber aspect ratio, the morphology of the fiber (e.g., stacked-cup, herringbone, etc.) and the extent to which the paper is compressed during manufacture. In one embodiment the aspect ratio of the nanofibers is greater than 100 and more particularly greater than 500.

Another advantage of such a low density nanofiber paper is that it is flexible. For example, flexibility is useful so that one can coil battery electrodes around small diameter mandrels so that a battery can be manufactured in a ‘jelly roll’ design. Low density nanofiber paper (prior to coating with silicon) can be coiled around a mandrel as thin as about 0.25 inches without fracturing. It may be coiled even more tightly if a polymeric binder has been added to it.

Techniques for silicon application are those that provide deposition deep into the material, and those techniques that produce a thin, adherent silicon layer. Carrying out the deposition at temperatures below about 500° C. promotes the formation of amorphous silicon rather than crystalline silicon. Amorphous silicon is less prone to lose structural cohesion upon repeated lithium insertion/deinsertion. Temperatures above 500° C. also tend to make the paper increasingly brittle and less flexible, as carbon nanofibers begin to bond to one another and form a more rigid matrix.

The silicon-modified nanofiber paper can be used as both an energy storage material and current collector. This is possible because: 1) the nanofiber paper can be made as a freestanding substrate in a thickness range appropriate for battery use (for example, about 2-20 mils); 2) the nanofiber paper, when constructed out of a suitable nanofiber, has sufficient conductivity (about 0.01 to about 100 ohm⁻¹-cm⁻¹) to make it useful as a current collector; and 3) the nanofiber paper's conductivity can be further enhanced by adding small amounts of a carbonizable additive that promotes a more contiguous matrix of nanofibers.

Deposits of silicon doped with other elements (as opposed to pure silicon) are also within the scope of this invention. For example, deposition processes that consist of thermal or photoassisted decomposition of a chlorine-containing silicon compound may incorporate small amounts of chlorine into the deposited layer. Other doping elements such as tin or boron might be incorporated with the intent of either improving cycling stability, eliminating the formation of unwanted phases such as crystalline Li₄Si₁₅, or improving the electrical conductivity of the silicon layer. Such modifications are well known to those in the art.

The carbonizable additive can consist of any organic material that does not volatilize under the carbonization conditions but will pyrolyze to leave behind a conductive carbonaceous residue that electrically connects individual nanofibers within the paper. These can include materials such as, but not limited to, polyacrylonitrile, furfuryl alcohol, pitches and tars, citric acid, and phenolic resins. They may be added in such a way as to localize the carbonaceous residue near the junction points of the nanofibers in the paper, as opposed to coating the fibers or forming web-like deposits. While not desiring to be bound, carbonizable additives may be added by infusing the paper with solutions of them, or dispersions of them, and then removing the carrier solvent. In one embodiment, a minimum amount of carbonizable additive is used that provides a beneficial conductivity enhancement, as higher quantities may increase the rigidity of the paper and make it less flexible. It is recommended to use less than about 2 wt. % of the additive determined based on the weight of the paper after carbonization. The carbonizable additive is added to the paper and carbonized prior to deposition of the silicon.

The nanofiber paper can also be made more conductive by incorporating metal nanofibrils into the paper. The preferred method is to make the nanofiber paper with a sufficient metal nanofibril content so that a contiguous, conductive network of metal can be formed in the paper structure. When using nickel nanofibrils from Metal Matrix Corp., a nanofibril content of greater than about 20 wt. % content is sufficient to create such a network. In one embodiment, the nickel nanofibrils in the paper are fused at their junction points by heating the nanofiber/nanofibril paper at temperatures above 375° C. in a reducing atmosphere such as hydrogen. The use of relatively low temperatures (e.g., about 375-475° C.) and a reducing atmosphere allows the resulting paper to remain flexible while providing enough heat for a low-temperature metal/metal bonding to occur, because in this environment the metallic surfaces are oxide-free. In addition to nickel, other metal nanofibers such as gold and copper may be useful.

The use of silicon-coated nanofiber paper as both energy storage material and current collector can allow one to significantly reduce a battery's weight by eliminating the metallic current collector, correspondingly improving the battery's energy storage on a weight basis. Silicon modification of carbon nanofiber paper not only produces an energy-storage material, it creates an electrode.

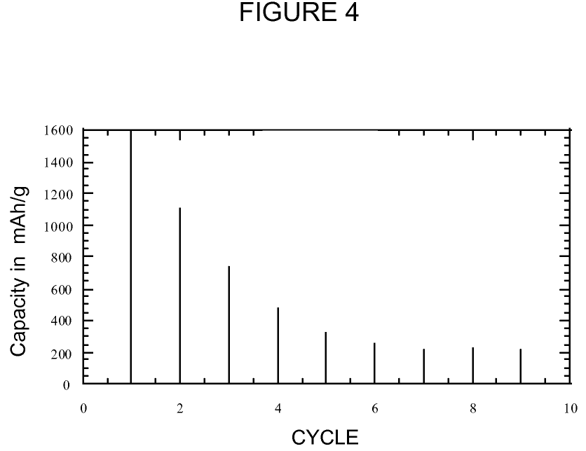

The disclosed electrode can be illustrated by contrasting its cycling stability with a similar nanofiber electrode that hosts silicon in the form of particulates blended into the nanofiber paper structure. Tests performed on the latter electrode type give an initially high capacity that drops dramatically during the first few charge/discharge cycles. A nanofiber paper containing 50% silicon particulate by weight, with a silicon particle size under 5 microns, shows the following results during the first few cycles: 1600 mAh/g, 1100 mAh/g, 740 mAh/g, 475 mAh/g, etc., finally leveling of at 225 mAh/g, which is the value of the carbon component by itself. A graph of the cycling data obtained with this type of electrode is shown in FIG. 4.

In one embodiment, a polymeric binder to the material is added to the paper after the silicon-deposition step to improve the toughness and flexibility of the silicon-coated nanofiber paper electrode. This may be done by infusing the silicon-modified paper with an organic or aqueous solution of polymers or elastomers, or with a fine-particulate emulsion or dispersion of polymer (elastomer), followed by removal of solvent. Alternatively, the polymer can be applied by electrostatic spraying, solvent spraying, thermal spray, or plasma spray techniques. Examples of such polymers include polyvinylidine fluoride (PVDF), ethylene propylene diene terpolymer, and co-polymers of vinylidene fluoride and hexafluropolypropylene. These may be incorporated into the paper in amounts ranging from about 0.5% to 15% by weight, and more particularly about 0.5 to 5.0% by weight based on the weight of the silicon coated paper.

The disclosed electrode is suitable as an anode for a secondary lithium ion battery, and it is also suitable as an anode material in an energy storage device known as a ‘hybrid’ or ‘asymmetric’ electrochemical capacitor. This is a rechargeable energy storage device designed to emphasize high power, as opposed to a battery's function of high energy storage. It consists of the disclosed battery anode mated with a cathode that exhibits high capacitance or pseudocapacitance, such as a high surface area carbon that stores energy through the double layer effect. This type of electrochemical capacitor is well known to those in the art.

### EXAMPLE 1

A 9-mil thick sheet of nanofiber paper was prepared according to the procedures described in patent application Ser. No. 11/586,358 (Carbon Nanofiber Paper and Applications). The paper was made from PR-25 nanofibers made by Applied Sciences in Cedarville Ohio, which have a individual density of 1.6 g/cc. The paper's density was 0.16 g/cc, making it 90% porous. This paper sample was first subjected to a vacuum treatment above 300° C. to improve its conductivity. After cooling, the paper was infused with a dilute solution of a carbonizable binder (mesophase pitch, 0.15% wt./wt. in pyridine). After air-drying, the sample was heated in an argon atmosphere to 475° C. to convert the pitch into a partially-carbonized binder that enhances the paper's conductivity. The amount of carbonized binder added with this procedure is approximately 0.5% of the paper's total weight.

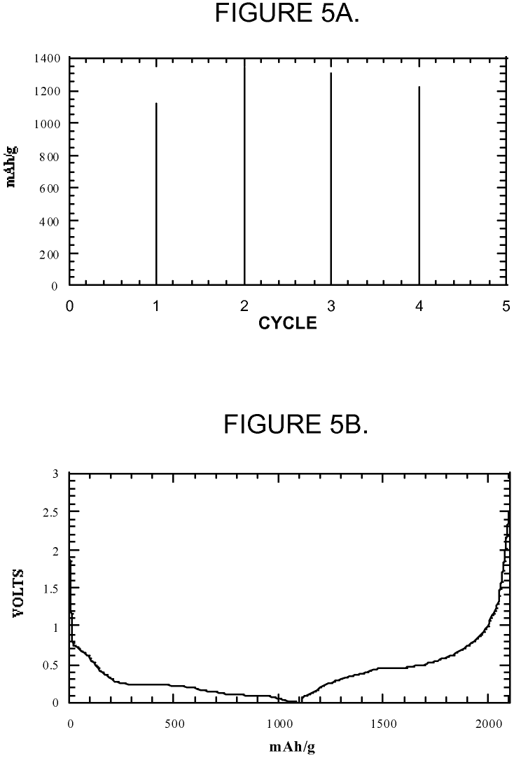

Next, the nanofiber paper sample was subjected to a silicon chemical vapor deposition (ultraviolet light assisted) process at a temperature between 400-500° C., using a tetrachlorosilane gas. The deposition process was engineered to deposit silicon throughout the entire thickness of the porous nanofiber paper. After the deposition, the silicon content of the treated paper was approximately 25% by weight. The paper sample was then examined as an anode in a lithium ion half-cell. Testing showed a reversible charge storage capacity for the first 4 cycles of 1100 mAh/g, 1400 mAh/g, 1300 mAh/g, and 1250 mAh/g. The charge/discharge voltage profile for the first cycle, and the capacity vs. cycling number are shown in FIGS. 5A and 5B.

### EXAMPLE 2

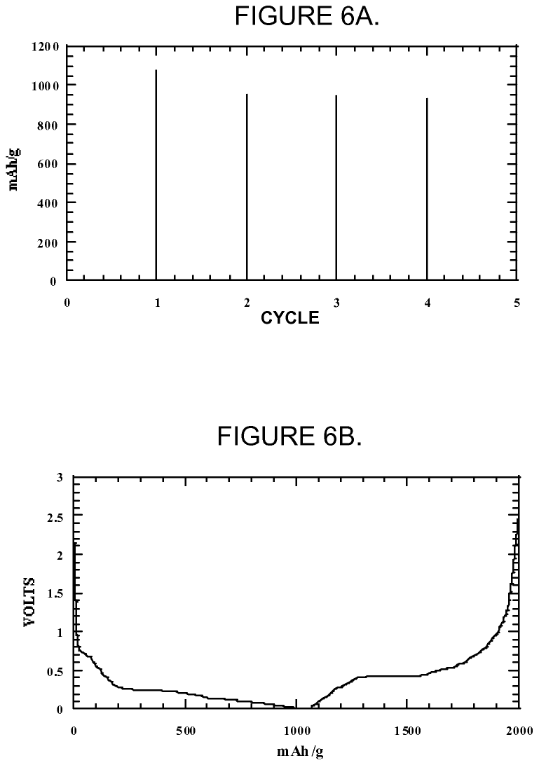

A sample of the same nanofiber paper substrate described in Example 1 was subjected to a similar Chemical Vapor Deposition process as used in Example 1. A similar amount of silicon deposited as in Example 1, namely about 20-25%. The resulting sample showed a reversible energy storage capacity for the first 4 cycles of 1000 mAh/g, 950 mAh/g, 950 mAh/g, and 925 mAh/g. The charge/discharge voltage profile for the first cycle, and the capacity vs. cycling number are shown in FIGS. 6A and 6B, respectively.

### EXAMPLE 3

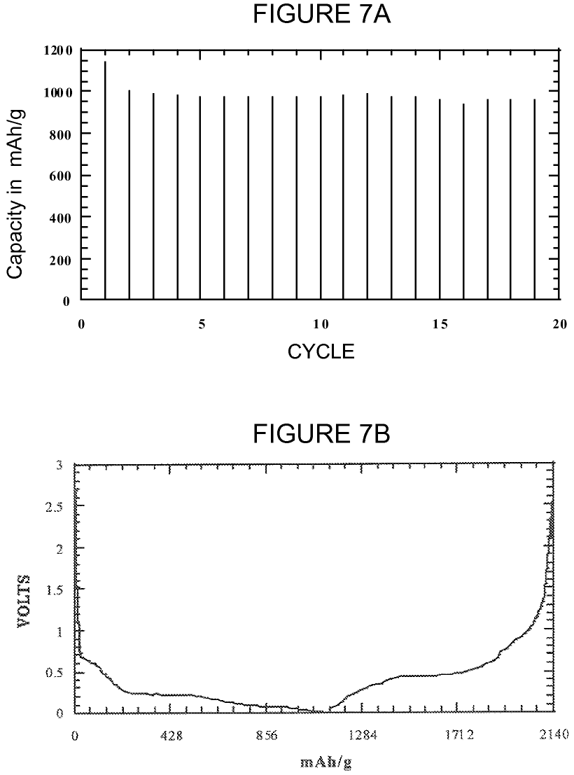

A sample of the same nanofiber paper substrate described in Example 1 was subjected to a similar Chemical Vapor Deposition method as used in Example 1. A gaseous silane agent was used, with deposition conditions that held the sample between 400-500° C. After this treatment the sample was approximately 29% silicon by weight. Electrochemical testing at approximately a C/15 rate showed close to 1000 mAh/g with good cycling stability, as shown in FIG. 7A. The charge/discharge voltage profile for the first cycle, and the capacity vs. cycling number are shown in FIGS. 7A and 7B, respectively.

### EXAMPLE 4

A 6-mil thick sheet of nanofiber paper was prepared according to the procedures described in patent application Ser. No. 11/586,358 (Carbon Nanofiber Paper and Applications). The paper was made from 92% PR-25 nanofibers made by Applied Sciences in Cedarville Ohio which have a individual density of 1.6 g/cc, and 8% of Nanoblack II, a nanofiber product (10 nm diameter) produced by Columbian Chemicals of Marietta Georgia. The paper's density was 0.24 g/cc, making it 85% porous. This paper sample was first subjected to a vacuum treatment above 300° C. It was next heated to 475° C. in a reducing atmosphere to enhance its conductivity. Unlike Examples 1, 2, and 3 above, no carbonizable binder was incorporated into this sample.

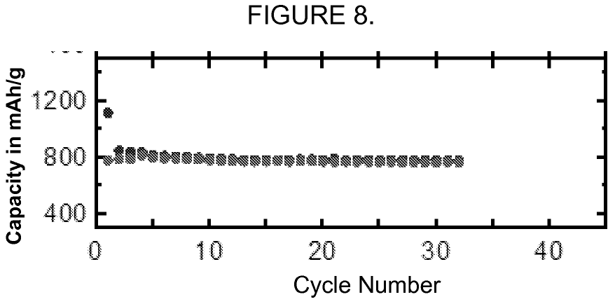

Next, the nanofiber paper sample was subjected to a UV-assisted silicon chemical vapor deposition process at a temperature between 400-500° C., using tetrachlorosilane gas. The deposition process was engineered to deposit silicon throughout the entire thickness of the porous nanofiber paper. After the deposition, the silicon content of the treated paper was approximately 25% by weight. The paper sample was then examined as an anode in a lithium ion half-cell. The testing protocol used for this sample differed compared to Examples 1, 2 and 3. During testing the sample was charged to only 65 mV vs lithium during its charge/discharge cycles, in contrast to Examples 1, 2 and 3 where samples were charged to near 0 volts vs. lithium. This test procedure produced an observed energy storage of 800 mAh/g with very stable cycling (i.e., no noticeable loss in energy storage upon cycling). The capacity vs. cycling number for this sample is shown in FIG. 8, where the first 3 cycles were performed at a charge/discharge rate of C/20 with subsequent cycles performed at C/10. The black dots correspond to the reversible capacity, while the gray dots correspond to the sum of the irreversible and reversible capacity. After 5 cycles, the black and grey dots substantially overlap.

Having described the invention in detail and by reference to particular examples thereof, it will be apparent that numerous variations and modifications are possible without departing from the invention as defined by the following claims.

What is claimed is:

1. A paper comprising a silicon-coated web of carbon nanofibers.

2. The paper of claim 1 where the carbon nanofibers include carbon nanofibers having a stacked-cup morphology.

3. The paper of claim 2 wherein the carbon nanofibers have a diameter less than about 100 nm.

4. The paper of claim 1 wherein the porosity of the carbon nanofiber web measured prior to coating with silicon is greater than about 50%.

5. The paper of claim 1 wherein the paper has a silicon content of about 10 to 90% by weight.

6. The paper of claim 1 wherein the silicon content of the paper is amorphous, crystalline, or a combination thereof.

7. The paper of claim 1 wherein the paper is formulated such that it is useful as an energy storage material, or as an energy storage material and current collector.

8. The paper of claim 1 wherein the silicon coating is applied by vapor deposition, chemical vapor deposition, UV-assisted chemical vapor deposition, or sputtering.

9. The paper of claim 8 wherein the silicon coating is produced by UV-assisted chemical vapor deposition.

10. The paper of claim 1 wherein the paper includes a polymeric binder.

11. The paper of claim 1 wherein the carbon nanofiber web contains a carbonized additive.

12. The paper of claim 1 wherein the carbon nanofiber web contains metallic nanofibrils.

13. The paper of claim 6 wherein the silicon coating is amorphous.

14. The paper of claim 1 wherein the silicon coating is about 2 to 200 nm thick.

15. The paper of claim 14 wherein the silicon coating is about 2 to 50 nm thick.

16. The paper of claim 14 wherein the silicon content of the paper is about 15 to 50%.

17. The paper of claim 11 wherein the carbonized additive is derived from a carbonizable additive selected from the group consisting of polyacrylonitrile, furfuryl alcohol, pitches and tars, citric acid, and phenolic resins.

18. The paper of claim 17 wherein the carbonized additive is present in an amount less than 2% by weight based on the weight of the web prior to coating with silicon.

19. The paper of claim 1 wherein the web has a density of about 0.05 to 0.8 g/cc prior to being coated with silicon.

20. The paper of claim 1 wherein the paper has a conductivity of about 0.01 to 100 ohm⁻¹-cm⁻¹.

21. The paper of claim 1 wherein the silicon is a doped.

22. A battery containing the silicon coated nanofiber paper of claim 1.

23. The battery of claim 22 wherein the paper is about 2 to 20 mils thick.

24. An asymmetric electrochemical capacitor containing the silicon coated nanofiber paper of claim 1.
